(19) United States
(12) Patent Application Publication
(10) Pub. No.: US 2019/0039710 A1
(43) Pub. Date: Feb. 7, 2019

(54) "HERACLES" AIRSHIP

(71) Applicants: Boris Solomonovich BABITSKIY, Haifa (IL); Irena WARDLE, Severn (CA)

(72) Inventors: Boris Solomonovich BABITSKIY, Haifa (IL); Irena WARDLE, Severn (CA)

(21) Appl. No.: 15/668,734

(22) Filed: Aug. 4, 2017

(51) Int. Cl. B64B 1/62; B64B 1/64; B64B 1/06

(52) U.S. Cl. CPC B64B 1/62; B64B 1/06; B64B 1/64

(57) ABSTRACT

The “Heracles” airship determines a new direction in airship construction by combining the buoyancy force and lifting force of a plane wing in its structure, thereby allowing the multiple increase of load-lifting capacity of the airship comparing to the known models while having comparable sizes.

The arrangement of solar panels on its upper semi-sphere provides energy independence, and time-unlimited remaining in flight makes it environmentally friendly.

It provides vertical ascending and landing, turning in a required direction, braking and maneuvering over a landing area on the ground and water.

In case of the emergency failure of the technical systems, safety systems are provided which allows using the airship for transporting large-tonnage loads and people.

The invention relates to an airship structure.

Airships of different constructions using buoyancy force for ascending the envelope of which is filled with lifting gases are known. The disadvantage of the structures like this is that they have large sizes but a low load-lifting capacity and require using different gases.

A design of an airship called “Aeroscraft Dragon Dream” using helium to produce buoyancy force is known.

The disadvantage of the structure like this is that it requires using helium, and has a low load-lifting capacity taking into account the claimed sizes of the airship.

The object of the invention is to provide an airship having high load-lifting capacity without the use of helium.

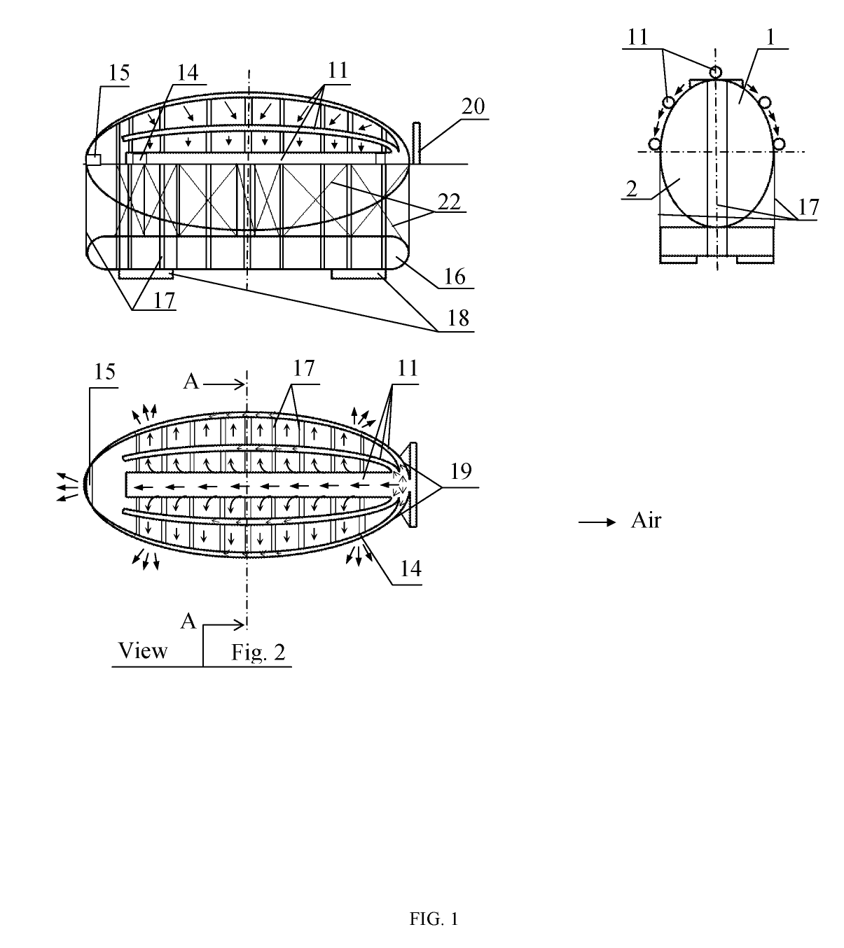

FIG. 1 schematically shows three views of the airship: a front view, a side view, and a top view.

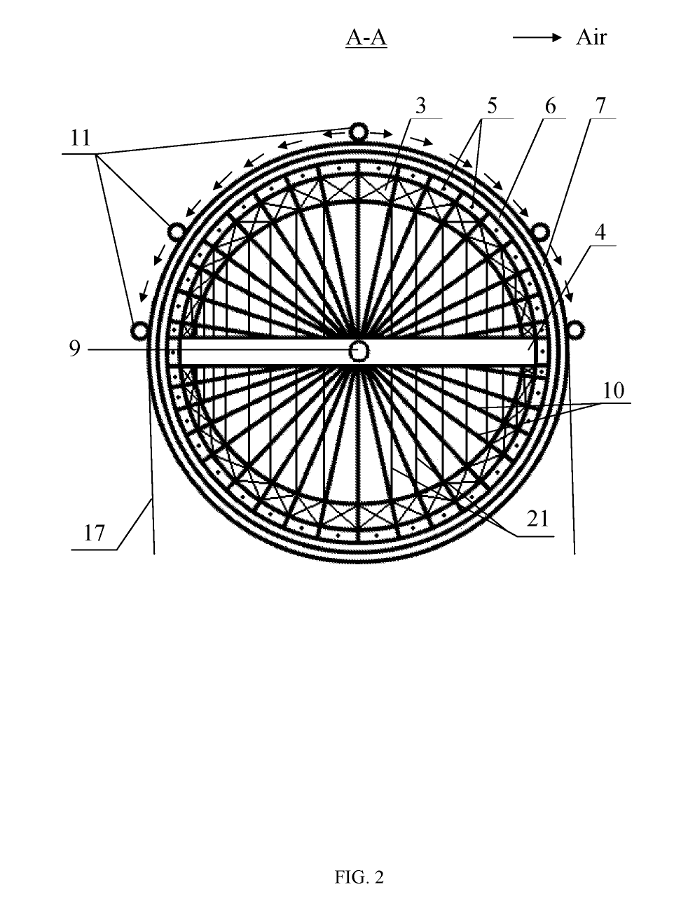

FIG. 2 shows a sectional view of the airship taken along an A-A line shown in FIG. 1.

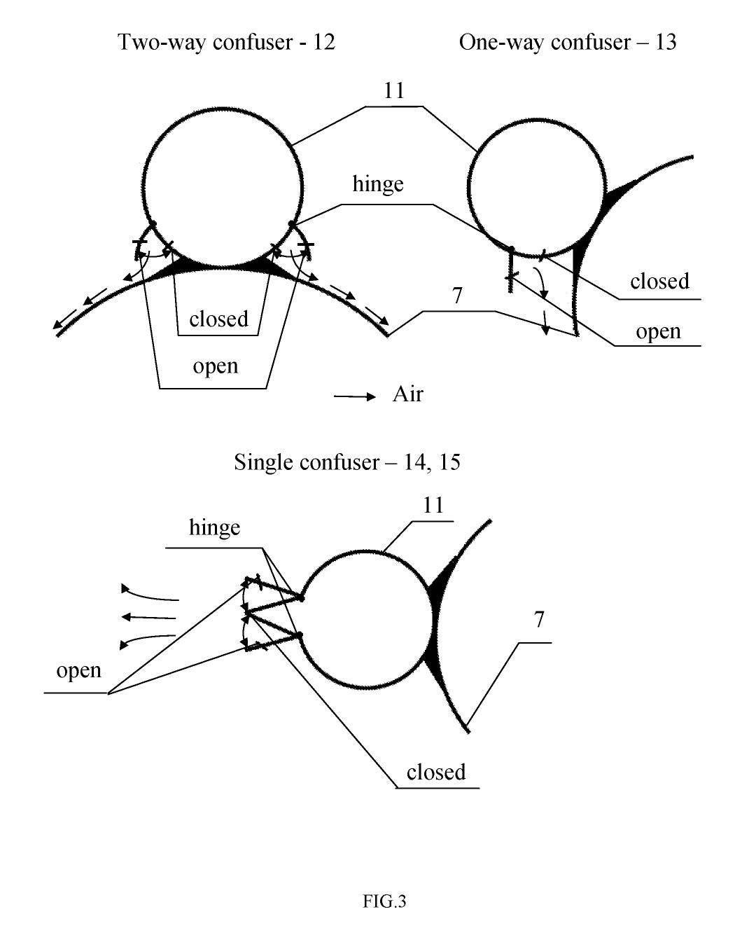

FIG. 3 shows a two-way confuser 12 and one-way confusers 13,15 arranged on extended external air ducts 11, in an open and closed state, and a one-way confuser 14 arranged on the extended external air ducts 11.

The object is achieved in that the airship is composed of two semi-spheres, an upwardly convex upper semi-sphere 1 and a downwardly convex lower semi-sphere 2 (FIG. 1), and comprises an inner framework made of a set of arches 3 arranged incrementally along the longitudinal axis of the airship in each of the semi-spheres (FIG. 2), the arches being supported by arch beams 4 (tie-beams).

On the top, the arches are interconnected by bearers (longitudinal beams) 5, wherein a wire binding 6 being arranged over the bearers and arches. The wires are arranged with stretching forces. Over the wire binding, an airtight multilayer coating 7 is applied, and solar panels 8 are arranged on the coating (not shown in FIG. 2). The multilayer coating can be made of heat shrinking materials.

The arches 3 are connected to the elements of a central axis 9 by radial bars (spokes) 10 stretched at an estimated value.

The arches 3 are connected to the beams 4 by vertical bars (spokes) 21 stretched at an estimated value.

The end sections of the airship are provided with arches supported by horizontal tie-beams and tie-beams arranged at right angle to the horizontal tie-beams.

The inner surfaces of the arches are connected to the elements of the central axis 9 by pre-stretched strings 10 (it is commonly known that, similar to bicycle spokes, stretched stressed strings are able to withstand the compressive force that will be applied to the outer surface of an airship when a vacuum is produced inside thereof). The bars (spokes) 21 function in the similar way.

As a result of the connection, said elements (except for the airtight coating 7) form the strong hull of the airship that is similar to the strong hull of a submarine and that in both cases experiences external pressure when a vacuum is produced inside the hull of the airship. (The estimation of the practical construction of the airship can be carried out by a company designing submarines).

For feeding compressed air (FIG. 1), an extended external air duct 11 comprising a two-way confuser 12 (FIG. 3, not shown in FIG. 1) that allows feeding compressed air on the both sides of the semi-sphere 1 is arranged on the top of the semi-sphere 1.

The confuser is configured to be opened and closed in a controlled manner that defines the speed change of the air coming therefrom. For feeding compressed air, extended external air ducts 11 comprising one-way confusers 13 (FIG. 3, not shown in FIG. 1 and FIG. 2) and configured to be opened and closed in a controlled manner are arranged on the side surfaces of the semi-sphere 1 (on the both sides).

Single confusers 14 (FIG. 3) arranged on the external air duct 11 for compressed air and configured to be opened and closed in a controlled manner are provided at the level of the horizontal tie-beams of the arches on both sides of the semi-sphere 1.

A single confuser 15 (FIG. 1) configured to be opened and closed in a controlled manner and connected to the external air duct 11 is arranged at the front of the semi-sphere 1 at the level of the horizontal tie-beams. All the air ducts 11 are connected mechanically but controlled individually which provides the stable positioning of the airship while in flight.

A cantilever platform 19 carrying propellers that provide the propulsion of the airship 20 is arranged at the back of semi-spheres (FIG. 1) at the level of the tie-beams.

Carrying straps (sheets) 17 connected with a cargo compartment and a control compartment 16 are laid over the semi-sphere (FIG. 1) with specific intervals.

The cargo compartment and the control compartment 16 (FIG. 1) connected along the entire length with the straps (sheets) 17 are arranged below the semi-sphere 2. The straps 17 are connected by cross braces 22.

Vacuum pumps connected with the inner volume of the airship through a check valve (not shown), compressors, intercoolers connected with the air ducts 11, compressed air vessels connected with the air ducts 11 by a stop valve, a valve connected with the inner volume of the airship and the atmosphere (not shown in the figures), and uninterruptible power devices (not shown in the figures) are arranged in the control compartment. The cargo compartment is provided with compressed air jacks 18. A container configured to open and close the doors in a controlled manner is arranged below the cargo compartment. There is an inflatable boat in the container. Controlled valves are arranged on the bottom of the boat.

The framework of the airship is assembled as follows. The beams 4 are mounted on the axis 9 incrementally along the longitudinal axis of the airship. The arches 3 that are connected with the elements of the axis 9 by the bars (spokes) 10 that are stretched at an estimated value are mounted on the beams 4. The arches 3 are connected with the beams 4 by the load carrying bars (spokes) 21 that are stretched at an estimated value. The end sections are mounted on the axis 9.

The beams 5 over which the wire binding 6 with wires stretched at an estimated value arranged are laid over the arches 3. The airtight multilayer coating 7 is applied over the wire binding. The places where the valves come out of the coating are reinforced by ribs from the inside.

The solar panels are mounted on the upper semi-sphere. The cargo compartment and the control compartment connected to the upper semi-sphere 1 by the straps (sheets) 17 are assembled separately.

The airship functions as follows.

At a mooring site on the ground, the airship is supported by the compressed air jacks 18 that allow setting the bottom of the cargo compartment in the horizontal position.

Upon loading, the vacuum pumps begin to operate (when the confusers and the valve connected with the atmosphere are closed), and air suction from the inner sealed cavity of the airship is performed. While the air is being sucked and the vacuum is being produced, the buoyancy force begins to act on the airship. If the predefined vacuum level is reached and the value of the buoyancy force is not sufficient for ascending the airship, the compressors begin to operate feeding compressed air through the intercoolers into the air ducts 11. The confuser 12 and confusers 13 on the air ducts 11 are opened. The semi-sphere 1 is cooled by the compressed air. Due to the Coanda effect, the air coming out under pressure at high speed is “attached” to the surface of the coating. This defines the air pressure reduction on the upper plane of the semi-sphere 1. The air pressure below the semi-sphere 2 remains atmospheric. The pressure difference above and below produces lifting force similar to the lifting force of a plane wing. The resultant action of the buoyancy force and the lifting force provides the ascending of the airship.

When the airship reaches a predetermined altitude, the confusers are opened more, and the speed of the leaving air is decreased which stops the ascending.

When the speed of the air leaving the confusers is, e.g., 35 meters per second, the load-lifting capacity of the “Heracles” airship is about 1500 tonnes (whereas the stated size of the Aeroscraft Dragon Dream is 75*30 meters and the load-lifting capacity is 50 tonnes). (The estimation of the load-lifting capacity is attached).

For the propulsion of the airship, propellers driven by frequency controlled asynchronous engines powered through converters by the solar panels can be used. In order to slow down the airship, the confuser 15 is used, wherein the confuser being arranged at the front of the airship and producing reactive force directed opposite to the direction of the movement of the airship when the air leaves. Turning the airship in a required direction is provided by the coordinated operation of the side confusers 14. The confusers 14 are used to manoeuvre the airship over a landing area. In order to descend the airship, the controlled valve is opened and the outer air enters the airship providing the decrease of the lifting buoyancy force, and the speed of the air leaving the confusers is decreased as well.

In order to provide safe landing (water landing) in case of the emergency shut-down of the compressors, the compressed air from the vessels is fed into the air ducts 11 automatically or manually.

For the water landing of the airship, the container containing the inflatable boat is opened, and the compressed air is fed to the boat. When the airship takes off from the water, the valves under the bottom of the boat are opened, and the compressed air is fed which facilitates the ascending of the airship.

The calculation of the elevating force of the “Heracles” airship

For the horizontal surface or horizontal airflow, the Bernoulli's equation looks as follows: pV²/2+P=CONST

It shows that the greater the speed of the airflow is, the less is the pressure, and vice versa.

In the equation: p(po)—air density, P (pressure)—pressure in the point of space, where the mass center of the air element is located, V—air speed in the flow.

The first (left) summand of the Bernoulli's equation is the kinematic energy of the flow, or the dynamic pressure. It is created by movement of the air. It is also called impact air pressure in the aviation.

The second summand P is a static pressure, put by neighboring air layers onto each other.

The form of the flying vehicle surface (wing) blown by air is as if it separates the air flow from the lower part. Thus, the pressure above the upper part of the wing is less than that beneath the lower one. Due to the difference between these pressures, the elevating force of wing appears.

Obviously, the left and right parts of the Bernoulli's equation have the dimension of the pressure.

At speed V=0, the first (left) summand of the equation equals 0 and P=const.

At the normal air pressure (within the height of 1000 meters), P=1.033 kg/cm². With increase of the speed V, the pressure P on the surface blown by air will reduce.

At speed V=30 m/sec and p(po)=1.293 kg/m³—table value Dynamic pressure will make:

1.293*(30)²/2=581.85 kg/m²=0.582 t/m²

Air pressure per the square meter:

1.033*10⁴=10.33 t/m²

The pressure on the wing with the square of 1 m blown by the air with the speed 30 m/sec will be reduced by value of the dynamic pressure and will make:

10.33−0.582=9.748 t/m²

With the wing square of 75*30=2250, the pressure on the lower surface not blown by air is:

10.33*2250=23242.5 t

The pressure on the upper surface of the wing blown by air is:

9.748*2250=21933 t

The difference of pressures−elevating force is:

23242.5−21933=1309.5 t

At speed V=35 m/sec, the dynamic pressure will make:

1.293(35)²/2=791.96 kg/m²=0.792 t/m²

With the wing square of 2250, the pressure on the lower surface remains the same.

The pressure per 1 square meter of the upper surface of the wing will be less by the value of the dynamic pressure:

10.33−0.792=9.538 t/m²

The pressure per 2250 square meters will make:

9.538*2250=21460/5 t/m²

The difference of pressures−elevating force is:

23242/5−21460/5=1782 t

### CONCLUSIONS

The selection of wing square parameters and speed of its blowing by air allow calculating the necessary value of the elevating force.

The “Heracles” airship has obvious advantages over the known structures owing to its increased load-lifting capacity (much larger than that of a prototype having the similar sizes), and is a new step in the development of airship construction. The present invention can be used in numerous ways to transport loads and people over the air.

### REFERENCE NUMBERS

1—upper semi-sphere;
2—lower semi-sphere;
3—arches of the inner framework of the upper and lower semi-spheres;
4—arch beams (tie-beams);
5—bearers (longitudinal beams);
6—wire binding;
7—multilayer airtight coating;
9—central axis;
10—radial bars (spokes);
11—extended external air ducts;
12—two-way confuser;
13—one-way confuser;
14,15—one-way confusers;
16—cargo compartment and control compartment;
17—straps (sheets);
18—compressed air jacks;
19—cantilever platform;
20—propellers that provide the propulsion of the airship;
21—vertical bars (spokes);
22—cross braces.

1. An airship comprising a closed rigid hull having a propulsion device mounted thereon and connected with a cargo compartment and a control compartment, wherein the airship comprises extended air ducts arranged on the top of the upper semi-sphere of the airship and on the sides of the semi-sphere, the air ducts comprising confusers used to change the speed of the exhaust air.
